(19) United States
(12) Patent Application Publication
(10) Pub. No.: US 2010/0226057 A1
(43) Pub. Date: Sep. 9, 2010

(54) ELECTRONIC VACUUM SWITCH WITH MAIN PARAMETERS QUICKLY SETTABLE ALSO DURING OPERATION OF THE PLANT UNDER CONTROL

(75) Inventor: Adriana Sartor, Milan (IT)

Correspondence Address: J. Rodman Steele;Novak Druce & Quigg LLP, 525 Okeechobee Blvd, Suite 1500, West Palm Beach, FL, 33401, US

(73) Assignee: ELETTROTEC s.r.L., Milan (IT)

(21) Appl. No.: 12/670,277

(22) PCT Filed: Jul. 22, 2008
(86) PCT No.: PCT/EP08/59602

§ 371 Date: Apr. 16, 2010

(30) Foreign Application Priority Data
Jul. 26, 2007 (IT) MI2007A 001511

(51) Int. Cl. H01H 73/02; H01H 33/66

(52) U.S. Cl. 361/115; 218/139

(57) ABSTRACT

An electronic vacuum switch is described comprising a connector (6) having means (7) for the seal-closing of an outer body (1) having a cavity (60) within which a negative pressure sensor (8) exposed to the negative pressure of the board (2) connected to the sensor (8) are housed. The negative pressure sensor is a ceramic pad integrated in a Wheatstone bridge (72) and the circuit board (2) is connected to said Wheatstone bridge (72) and comprises means (86) for the calibration of the Wheatstone bridge which are manually settable.

The present invention relates to an electronic vacuum switch with main parameters quickly settable also during operation of the plant under control.

The possibility of quickly and precisely setting a vacuum switch is of crucial importance for optimising operation of the plant to which the vacuum switch is fitted.

Object of the present invention is to make a vacuum switch of simple construction in which the setting means can be adjusted without having to stop the plant to which it is connected and with respect to which it has to control the presence of vacuum.

According to the present invention such object is achieved by means of an electronic vacuum switch comprising a connector having means for the seal-closing of an outer body having a cavity within which a negative pressure sensor exposed to the negative pressure of the environment under control and a circuit board connected to the sensor are housed, characterised in that said negative pressure sensor is a ceramic pad integrated in a Wheatstone bridge and said circuit board is connected to said Wheatstone bridge, said circuit board comprising means for the calibration of the Wheatstone bridge which are manually settable.

These and other characteristics of the present invention will be made more evident by the following detailed description of practical embodiment, illustrated in a non-limitative way on the attached drawings, in which:

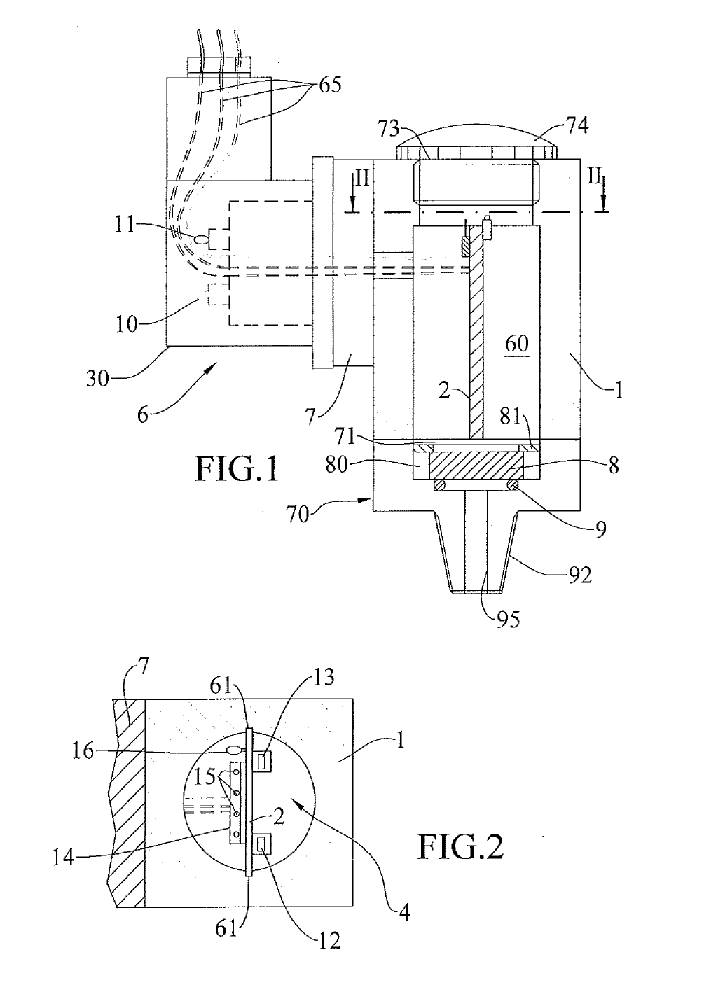

FIG. 1 shows a front view, partially sectioned axially, of the vacuum switch according to the present invention;

FIG. 2 shows a section view according to the line II-II of FIG. 1;

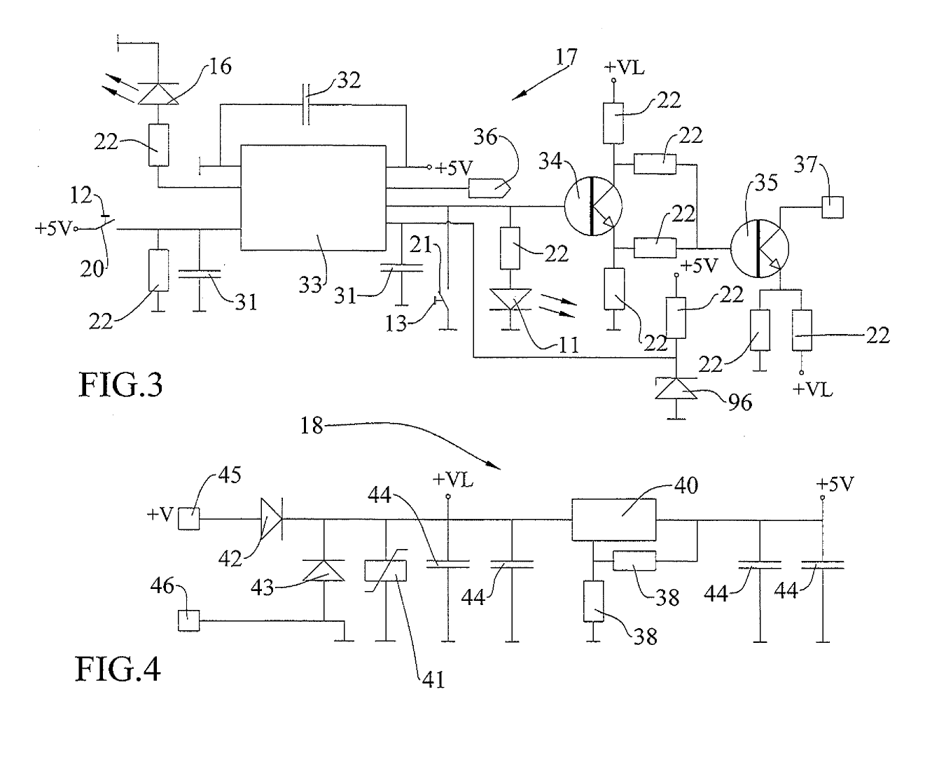

FIG. 3 shows the main part of the circuit board of said vacuum switch;

FIG. 4 shows a power and protection circuit comprised in said circuit board;

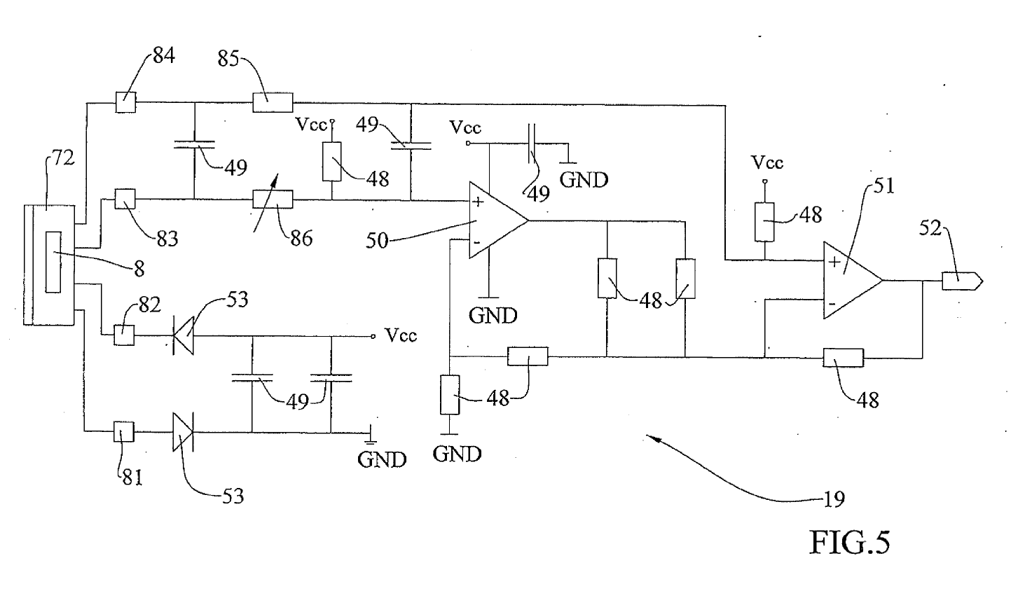

FIG. 5 shows an amplification circuit of the signal provided by the vacuum sensor.

The electronic vacuum switch shown in the FIGS. 1 and 2 comprises an outer body 1 in aluminium with a cylindrical cavity 60 having a pair of longitudinal grooves 61 engageable in a removable way with the extremities of an extractable flat circuit board 2.

On the side surface of the body 1 a connector 6 is fastened which has a transparent cover 30 and a removable plate 7 for seal-closing the cavity 60. Inside the connector 6 luminous indicator LEDs 10-11 are placed, able to emit a yellow and red light visible respectively through the transparent cover 30. The connector 6 is furthermore crossed by electric wires 65 for the outer electrical connection of the circuit board 2.

In the lower part of the body 1 a steel flange 70 is fastened having a cavity 71 in which, by means of a ring nut 80 and a spacer 81, a vacuum sensor is fastened, i.e., a ceramic pad negative pressure sensor 8 with relevant seal 9, underneath which is a threaded connection 92 for connecting up to the plant to be controlled, with an inner inlet channel 95 for the controlled fluid.

Said flange 70 can be released from the body 1 and is generally made of more resistant material than the body 1 to be able to work at very high operating pressures. It can furthermore be replaced with another flange of different material variable along with the desired operating pressure or for more aggressive fluids.

The circuit board 2 supports setting means 4 comprising setting keys 12-13, a luminous indicator LED 16 emitting green light, a luminous indicator LED 11 emitting red light and a serial port 14 having connection feet 15 for connecting, by means of the wires 65, up to an external personal computer or other means for the entering/collection of data.

Said keys 12-13 can be reached by the operator through a threaded opening 73 placed in line with the head of the body 1 and normally closed by a removable threaded cover 74.

From a circuit viewpoint, the board 2 comprises a main circuit 17 (FIG. 3), a power and protection circuit 18 (FIG. 4) and a circuit 19 for the detection and the amplification of the signal coming from the sensor 8 (FIG. 5).

The main circuit 17 comprises switches 20-21 controlled by the setting keys 12-13 respectively, a microprocessor 33 with internal E²PROM memory and a feedback capacitor 32, a switchover transistor 34, a power transistor 35, the LEDs 11 and 16, various resistances 22, stabilisation capacitors 31, a zener diode 96, ground connections, an input 36 and an output 37.

The power and protection circuit 18 comprises a pair of input terminals 45-46, diodes 42-43 for protecting against voltage inversions, a variable resistance 41, a voltage converter-stabiliser 40, resistances 38, capacitors 44 and various ground connections.

Finally, the detection and amplification circuit 19 comprises terminals 81 and 82 to which the terminals of the vacuum sensor 8 are connected for the connection to ground GND and with the reference voltage VDC and to which terminals 83 and 84 pre connected for detecting the vacuum signal; between the terminals 81, 82 and 83, 84 a Wheatstone bridge is placed of which the ceramic pad 8 is a part. The terminal 84 is coupled to the non-inverting terminal of an amplifier 51 by means of a resistance 85 while the terminal 83 is connected to the non-inverting terminal of an amplifier 50 by means of a variable resistance 86. The circuit 19 comprises an output 52 connected to the input 36 of the circuit part 17 of FIG. 3, diodes 53 and resistances 48 and capacitors 49 and various ground connections GND. The variable resistance 86 can be set manually and permits the calibration of the Wheatstone bridge according to the negative pressure to be detected. In fact, at a pressure of 0 bar, the Wheatstone bridge, at its ends, normally shows a negative voltage offset that does not allow the operation of the amplification circuit 19 of the vacuum switch; by operating on the variable resistance, it is possible to balance the Wheatstone bridge and compensate such power offset.

The manual setting of the vacuum switch is rather simple.

The green LED 10 is associated with the power supply circuit of the vacuum switch (not shown in the FIGS. 3-5) with the task of indicating the presence of the power supply itself.

The vacuum switch is considered mounted on the plant or machine under control with the operating negative pressure (e.g., −0.800 mbar) brought to the desired running value. Such negative pressure is detected by the ceramic sensor 8, which determines an unbalance of the Wheatstone bridge 72 once calibrated by means of the variable resistance 86; said unbalance in turn translates into an electric amplitude signal corresponding to the detected negative pressure, present at the output 52 of the amplification circuit 19 of FIG. 5 and at the input 36 of the microprocessor 33 of the circuit part 17 of FIG. 3.

To access the setting keys 12-13 simply remove the cover 74. The plant or the machine under control does not have to be stopped. The presence of the power supply in the vacuum switch is indicated by the lighting up of the green LED 10 on the connector 6.

By keeping the key 12 pressed for at least three seconds, the negative pressure value at the input 36 is acquired as operating value by the memory of the microprocessor 33, with consequent lighting up of the green LED 16 by way of indication.

Each acquisition of a new operating value automatically also sets the reset threshold (hysteresis) according to a minimum hysteresis value.

To set a different reset threshold, the plant must be brought to the desired reset negative pressure value and then the white key 13 must be kept pressed for at least three seconds. In this case as well, the green LED 16 lights up to confirm the acquisition of the reset value by the microprocessor 33 and the related memory.

Once the vacuum switch has been set, the opening 73 can be covered again with the cover 74.

During operation, the red LED 41, on the connector 6, lights up to indicate the set switching value has been reached. In turn, the transistors 34 and 35 are switched by the microprocessor 33 in saturation or in interdiction to electrically indicate to the outside, by means of the wires 65, the operating or reset state of the vacuum switch.

In the event of its being necessary to programme the instrument again, all that need be done is repeat the above procedure with different pressure values.

Before acquiring a new value (intervention or reset) a test is performed on the E²PROM memory. This test is indicated by the flashing in rapid succession of the green LED 16 before the visual data acquisition signal.

Besides a considerable setting speed, said vacuum switch is very flexible because the possibility of transforming an operating mode with “normally open” contact (meaning with output 37 of FIG. 3 normally without signal) into an operating mode with “normally closed” contact (meaning with output 37 normally with signal) exists by pressing the keys 12-13 at the same time for a few seconds. In point of fact, we have two vacuum switches in one.

More precisely, the ceramic pad 8 detects the plant operation negative pressure and, if exceeds the operating value, it forms creates an unbalance of the Wheatstone bridge 72 of FIG. 5 with consequent application, by means of the output 52 of FIG. 5 and the input 36 of FIG. 3, of a negative pressure signal to the microprocessor 33. The latter then commands the interdiction of the transistor 34, which in turn conveys in interdiction the power transistor 35. The red LED 11 lights up commanded by the diode 41.

Furthermore, the board 2 has a protection circuit 18 for any short circuits and wrong power connections.

An inverse behaviour, with saturation of the transistors 34 and 35 and switching off of the red LED 11, is determined by the return of the negative pressure below the reset threshold.

Finally, the setting keys 12-13 can be used to introduce codes for programming lock/release. The operator can carry out setting operations only if he/she knows the set combination of the keys 12-13 (e.g., press key 12 twice, key 13 once and key 12 again three times). Such code is managed by a software integrated in the circuit board 2.

The vacuum switch according to the present invention therefore allows working with the utmost safety, quickly setting the fundamental operating parameters and avoiding frequent maintenance operations.

1. Electronic vacuum switch comprising a connector (6) having means (7) for the seal-closing of an outer body (1) having a cavity (60) within which a negative pressure sensor (8) exposed to the negative pressure of the environment under control and a circuit board (2) connected to the sensor (8) are housed, characterised in that said negative pressure sensor is a ceramic pad integrated in a Wheatstone bridge (72) and said circuit board (2) is connected to said Wheatstone bridge (72), said circuit board (2) comprising means (86) for the calibration of the Wheatstone bridge which are manually settable.

2. Vacuum switch according to claim 1, further comprising a setting means (4) comprising at least one key (12-13), said connector (6) being connected to the side surface of the outer body (1) and said cavity (60) communicating through an opening (73) placed at the head of said body (1) and normally covered by a removable cover (74) to enable the operator to reach said setting means (4).

3. Vacuum switch according to claim 2, further comprising a removable flange (70) with a coupling (92) for connection with the environment to be controlled, said removable flange (70) being connected to the outer body (1) at the opposite extremity to that where said opening (73) with removable cover (74) is present.

4. Vacuum switch according to claim 3, wherein said flange (70) is made of more resistant material than the outer body (1).

5. Vacuum switch according to claim 2, wherein said setting means (4) act on a software integrated in the board (2) so as to provide the possibility of forbidding the setting by means of block code managed by the software itself.

6. Vacuum switch according to claim 2, wherein said setting means (4) comprise a first key (12) for setting the operating value and a second key (13) for setting the reset value.

7. Vacuum switch according to claims 5, wherein said block code is entered by the operator by means of said first (12) and second (13) setting key.

8. Vacuum switch according to claim 2, further comprising a luminous LED (10) to indicate the presence of the power supply and a luminous LED (11) to indicate that the set switching value has been reached.

9. Vacuum switch according to claim 2, further comprising a luminous LED (16) to indicate the operating value setting, the reset value and the type of output contact.

10. Vacuum switch according to claim 1, wherein an unbalance of the calibrated Wheatstone bridge (72) causes the emission of a signal when the vacuum of the environment under control is above the operating value and said circuit board (2) comprises a microprocessor (33) having a memory, that receives the signal of the Wheatstone bridge (72) and according to this determines the presence or absence of an output signal, said setting means (4) acting on the microprocessor (33) to store the values of the signal of the Wheatstone bridge (72) which represent the operating and reset values of the vacuum switch.

11. Vacuum switch according to claim 1, wherein said circuit board comprises a power supply circuit (18) of the sensor and said calibration means comprise a variable resistance (86), said variable resistance being set so as to compensate a negative voltage offset present at the ends of the Wheatstone bridge (72) supplied by said power supply circuit and in the presence of the vacuum.
